(19) United States
(12) Patent Application Publication
(10) Pub. No.: US 2015/0088692 A1
(43) Pub. Date: Mar. 26, 2015

(54) SYSTEM AND METHOD FOR IDENTIFYING AND PURCHASING PRODUCTS FOR PERFORMING A TASK

(71) Applicants: Eric M. Fung, Alexandria, VA (US); Ann E. Dingle, Alexandria, VA (US)

(72) Inventors: Eric M. Fung, Alexandria, VA (US); Ann E. Dingle, Alexandria, VA (US)

(21) Appl. No.: 14/327,981

(22) Filed: Jul. 10, 2014

Related U.S. Application Data
(60) Provisional application No. 61/883,007, filed on Sep. 26, 2013.

(51) Int. Cl. G06Q 30/06; G06Q 10/08

(52) U.S. Cl. CPC G06Q 30/0623; G06Q 30/0633; G06Q 10/087; G06Q 30/0643
USPC 705/26.61

(57) ABSTRACT

Systems and methods for identifying and purchasing products required to perform tasks are described. In one embodiment, the systems and methods enable a user to identify products required to perform tasks and to add such products to a shopping cart. The system and method further recommends additional tasks that can be carried out by using the products that the user has already added to his shopping cart or by adding one, two, three, etc., additional products. In accordance with a further embodiment, the system and method enables a returning user to indicate how much remains of previously-purchased products and then, based on this information, recommends tasks that can be carried out by using the remaining products or by adding one, two, three, etc., additional products.

### CROSS-REFERENCE TO RELATED APPLICATIONS

This application claims priority to U.S. Provisional Patent Application No. 61/883,007, filed Sep. 26, 2013, and entitled “System and Method for Identifying and Purchasing Products for Performing a Task,” the entirety of which is incorporated by reference herein.

### BACKGROUND

1. Technical Field

The disclosure relates to systems and methods that assist users in obtaining information about products needed to perform certain tasks and in purchasing such products, wherein the obtaining of the information and purchasing of the products may be conducted via an electronically-implemented communication channel, such as via the Internet.

2. Summary of Art

Recently, interest in performing tasks by individuals, rather than by hiring professionals, has greatly increased. Tasks related to cooking and preparing meals, event planning, as well as do-it-yourself projects for homes and automobiles, are now often undertaken by hobbyists and individuals instead of relying on contractors, mechanics, and other professionals like chefs in restaurants and event coordinators. However, there is inherent difficulty involved in obtaining all the products necessary to perform certain tasks such as preparing specialty ethnic foods, performing home improvement or maintenance projects, automotive repair or maintenance projects, computer upgrade or maintenance projects, arts and crafts projects, beverage preparation (mixology), event planning, etc., and then maximizing the usage of such products after they have been purchased. Products such as building materials, automobile products, recipe ingredients, and/or the like may be hard to find and even harder to fully utilize when excess products remain on hand after completion of a task.

For instance, the preparation of specialty ethnic foods is becoming more popular in everyday cooking, and many home cooks are faced with significant barriers to consumption. The largest barrier is that typical supermarkets do not carry the ingredients necessary to make authentic ethnic cuisine. But when home cooks purchase ethnic ingredients from a specialty grocery store, these cooks often only use a small portion of the entire ingredient bottle or package for one recipe because of the inconvenience of returning to the specialty grocery store and a lack of knowledge about what other dishes they can cook using that ingredient.

### SUMMARY

Systems and methods are described for identifying and purchasing products for performing a task, substantially as shown in and/or described herein in connection with at least one of the figures, as set forth more completely in the claims.

### BRIEF DESCRIPTION OF THE DRAWINGS/FIGURES

The accompanying drawings, which are incorporated herein and form part of the specification, illustrate embodiments of the present invention and, together with the description, further serve to explain the principles of the invention and to enable a person skilled in the relevant art(s) to make and use the invention.

FIG. 1 depicts an example system that enables a user to identify and purchase products needed to perform tasks.

FIG. 2 depicts a graphical user interface (GUI) component that may be presented by the system of FIG. 1 and by which a user can search for recipes.

FIG. 3 depicts a GUI component that may be presented by the system of FIG. 1 in response to the selection of certain recipe categories, wherein the GUI component includes recipes that satisfy the constraints/filters represented by the selected categories.

FIG. 4 depicts a GUI component that may be displayed to a user by the system of FIG. 1 in response to the user's selection of a recipe, wherein the GUI component includes specialty ingredients necessary for following the selected recipe, pricing information associated with the specialty ingredients, and a means for adding the specialty ingredients to a shopping cart.

FIG. 5 depicts a GUI component that may be presented to a user by the system of FIG. 1, the GUI component providing the user with an identification of other recipes that can be made with specialty ingredients already in his shopping cart and with the purchase of one, two, three, or four more specialty ingredients.

FIG. 6 depicts a GUI component that may be presented to a user by the system of FIG. 1 when the user opts to view his shopping cart, wherein the example GUI component includes a list of the specialty ingredients that the user has added to his shopping cart, a list of the recipes that were accessed by the user to add such specialty ingredients, and a list of non-specialty ingredients required to complete such recipes. The GUI component of FIG. 6 also includes a means by which the user can complete a check-out process, a means by which the user can elect to receive a shopping list for non-specialty ingredients, and a means by which the user can view additional recipe suggestions based on the current contents of their shopping cart.

FIG. 7 depicts a flowchart of a process by which a user may interact with the system of FIG. 1 to identify and purchase specialty ingredients for preparing culinary dishes in accordance with an embodiment.

FIG. 8 depicts a GUI component that may be displayed by the system of FIG. 1 to a returning user and that provides a means by which such returning user can indicate how much of a previously-purchased specialty ingredient remains.

FIG. 9 depicts a GUI component that may be presented to a user by the system of FIG. 1 in response to receiving an estimated quantity of a previously-purchased specialty ingredient, the GUI component providing the user with an identification of other recipes that can be made with the remaining portions of his previously-purchased specialty ingredients and with the purchase of one, two, three, or four more specialty ingredients.

FIG. 10 depicts a flowchart of a process by which a user may interact with the system of FIG. 1 to receive recommended recipes for preparing culinary dishes in accordance with an embodiment.

FIG. 11 is a block diagram of an example processor-based computer system that may be used to implement various features and embodiments described herein.

FIGS. 12-17 depict flowcharts of processes by which portions of the system of FIG. 1 may operate to identify and facilitate the purchase of products for performing tasks.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### 1. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of persons skilled in the relevant art(s) to implement such feature, structure, or characteristic in connection with other embodiments whether or not explicitly described.

The terms “about,” “substantially,” and “approximately” may be used interchangeably and are intended to convey the same meaning.

Numerous exemplary embodiments are now described. Any section/subsection headings provided herein are not intended to be limiting. Embodiments are described throughout this document, and any type of embodiment may be included under any section/subsection. Furthermore, disclosed embodiments may be combined with each other in any manner.

### 2. Example Embodiments

Systems and methods for identifying and purchasing products required to perform tasks are described herein. In one example embodiment, a system and method enables a user to identify and purchase specialty ingredients required to prepare culinary dishes, such as ethnic culinary dishes. In particular, the system and method enables the user to search for desired recipes and identifies specialty ingredients necessary for preparing a dish in accordance with such desired recipes, which the user can then add to an electronic shopping cart. The system and method further recommends additional recipes that can be carried out by using the specialty ingredients that the user has already added to his shopping cart or by adding one, two, three, etc., specialty ingredients. The user is further enabled to access such additional recipes and to add additional specialty ingredients associated therewith to his shopping cart.

In accordance with a further embodiment, the system and method enables a returning user to indicate how much remains of previously-purchased specialty ingredients and then, based on this information, recommends recipes that can be carried out by using the remaining specialty ingredients or by adding one, two, three, etc., specialty ingredients.

By operating in the aforementioned manner, systems and methods described herein make users savvier with respect to specialty ethnic foods by giving them more access to specialty ingredients, and also by providing users with suggestions regarding other specialty ethnic foods to make with ingredients already in their electronic shopping cart and/or with ingredients that they previously obtained via the system or in some other manner.

In a still further embodiment, systems and methods described herein generate a list of remaining non-specialty ingredients needed to follow recipes that have been selected by a user and electronically deliver the list to an e-mail account, device or computer owned by or associated with the user, thereby enabling the user to more easily acquire such non-specialty ingredients from a local non-specialty supermarket.

The techniques and embodiments described herein provide for improvements in user shopping experiences and endeavors, including but not limited to culinary endeavors. In an example aspect, a system is disclosed that enables a user to identify and purchase products required to perform a task. The system includes a shopping engine configured to identify products required to perform a task, and to maintain a record of products selected for purchase by the user. The shopping engine is also configured to receive an indication of one or more of the identified products to be added to the record of products selected for purchase by the user, identify one or more additional tasks based on the one or more products that have been added to the record of products selected for purchase by the user, and provide the one or more additional tasks to a shopping tool for presentation to the user.

In another example aspect, a system is provided that enables a user to identify and purchase products required to perform a task. The system includes a shopping engine that is configured to maintain a record of products that a user has previously acquired, and to receive an indication of how much remains of each product that the user has previously acquired. The system is also configured to identify one or more tasks based on at least the indication, and to provide the one or more tasks to a shopping tool for presentation to the user.

In yet another example aspect, a method is disclosed for enabling a user to identify and purchase products required to perform a task. The method includes providing, for presentation to the user, an identification of products required to perform a task, and in response to an indication of a first input from the user, adding one or more of the identified products to a record of products selected for purchase by the user. The method also includes identifying one or more additional tasks based on the one or more products that have been added to the record of products selected for purchase by the user, and providing, for presentation to the user, the one or more additional tasks.

In still another example aspect, a computer-readable storage medium is disclosed having computer program instructions recorded thereon that, when executed, enable a processor-based system to perform a method. The method includes providing a shopping tool to a user and receiving an indication of a task from the user via the shopping tool. The method also includes displaying, via the shopping tool, products associated with performing the task to the user and enabling the user to add one or more of the products to a record of products selected for purchase by the user. The method further includes displaying one or more additional tasks to the user, the one or more additional tasks being displayed based on the one or more products that have been added to the record of products selected for purchase by the user.

Various example embodiments are described in the following subsections. In particular, example embodiments of a system for identifying and purchasing products required to perform tasks are described, followed by example embodiment variations. This is followed by a description of an example processor-based system implementation. Finally, some concluding remarks are provided.

### 3. Example System for Identifying and Purchasing Products Required to Perform Tasks

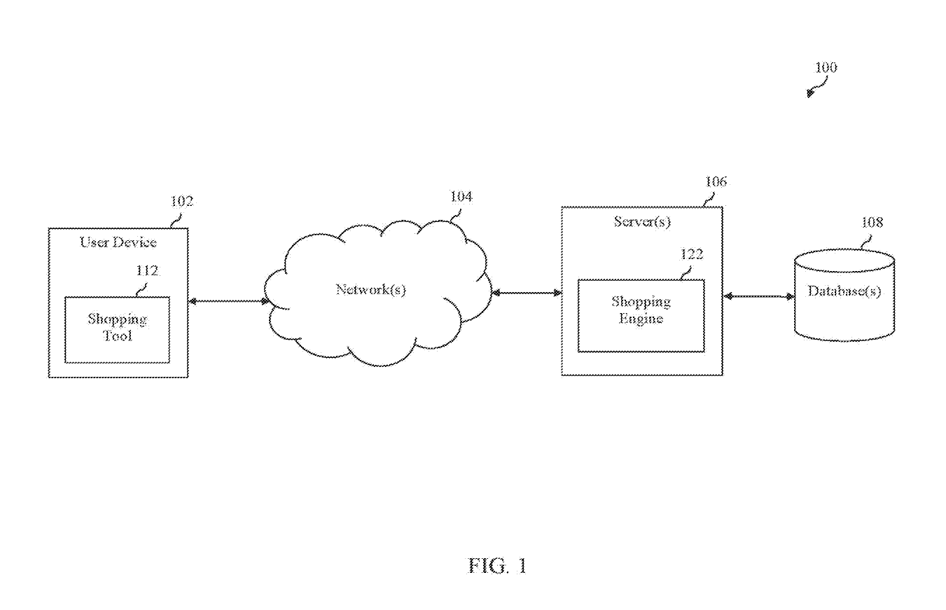

FIG. 1 depicts an example system 100 in accordance with an embodiment that enables a user to identify and purchase products needed to perform tasks. As shown in FIG. 1, system 100 includes a user device 102 that is communicatively connected to one or more servers 106 via one or more network(s) 104. User device 102 provides a user thereof with access to a shopping tool 112. Shopping tool 112 interacts with a shopping engine 122 that is implemented by server(s) 106 by communicating therewith via network(s) 104. Via such interaction, shopping engine 122 and shopping tool 112 jointly enable a user of user device 102 to identify and purchase products needed to perform tasks in a manner that will be described in more detail herein.

User device 102 is intended to broadly represent any type of electronic device or system that is capable of implementing or executing a shopping tool such as shopping tool 112. By way of example only and without limitation, user device 102 may comprise a desktop computer, a laptop computer, a tablet computer, a smartphone, a personal digital assistant, a gaming console, a shopping kiosk, or the like.

Each of server(s) 106 is intended to broadly represent any type of electronic device or system that is capable of implementing or executing a shopping engine such as shopping engine 122. By way of example only and without limitation, each of server(s) 106 may comprise a computer that is configured to perform services on behalf of other computers or electronic devices, such as user device 102. In an embodiment in which network(s) 104 comprise the World Wide Web, server(s) 106 may include at least one Web server that is configured to present content to user device 102 (and other user devices) via network(s) 104.

Network(s) 104 are intended to represent one or more links between computers or other electronic devices that enable the communication of data there between. Network(s) 104 may comprise any type of network, including but not limited to local area networks (LANs), wide area networks (WANs) such as the Internet, personal area networks, telecommunication networks, or the like. Network(s) 104 may further comprise one or more wired and/or wireless networks. Communication over network(s) 104 may be carried out using any of a wide variety of well-known wired and wireless network communication protocols.

Shopping tool 112 is intended to represent logic or functionality that is implemented on user device 102 and is configured to assist a user thereof in identifying and purchasing products needed to perform tasks, wherein providing such assistance includes interacting with shopping engine 122 via network(s) 104. Shopping tool 112 may be thought of as the “front end” of system 100. In one example embodiment, shopping tool 112 comprises a Web site that is served by server(s) 106 and hosted in a Web browser implemented on user device 102. In another example embodiment, shopping tool 112 comprises an application that is installed on user device 102 and is executed thereon. In further accordance with such an embodiment, shopping tool 112 may comprise an application (“app”) that can be obtained by a user of user device 102 from an application store or other source accessed via network(s) 104 and then installed for execution on user device 102. However, these are examples only and persons skilled in the relevant art(s) will readily appreciate that the logic or functionality of shopping tool 112 may be implemented in other ways as well.

Shopping engine 122 is intended to represent logic or functionality that is implemented on server(s) 106 and is configured to perform functions in response to communication with shopping tool 112, wherein such functions assist in enabling a user of shopping tool 112 to identify and purchase products required to perform a task. Shopping engine 122 may be thought of as the “back end” of system 100. As will be discussed in more detail herein, the functions performed by shopping engine 122 may include but are not limited to, accessing task information stored in one or more database(s) 108 wherein such task information may include an identification of product(s) needed to perform a task, providing such task information to shopping tool 112 for presentation to a user, maintaining a record in the form of a list or other data structure (e.g., a “shopping cart”) of products) that a user of shopping tool 112 wants to purchase, and transacting purchases of such product(s) on behalf of a user of shopping tool 112. Still other functions that may be performed by shopping engine 122 will be described herein.

Each of shopping tool 112 and shopping engine 122 may be implemented in hardware (e.g., as digital and/or analog circuits), as software or firmware that is executed by one or more microprocessor(s), or as a combination of hardware and software.

The manner in which shopping tool 112 and shopping engine 122 operate to enable a user of user device 102 to identify and purchase products required to perform tasks will now be described in the context of an embodiment in which the tasks involve preparing culinary dishes, such as culinary dishes including specialty ethnic ingredients. However, it is to be understood that system 100 is not limited to such an embodiment. Rather, as will be appreciated by persons skilled in the relevant art(s) based on the teachings provided herein, the systems and methods described herein can be used to enable a user to identify and purchase products required to perform other types of tasks such as beverage preparation (mixology), home improvement or maintenance projects, automotive repair or maintenance projects, computer upgrade or maintenance projects, arts and crafts projects, event planning projects, or the like.

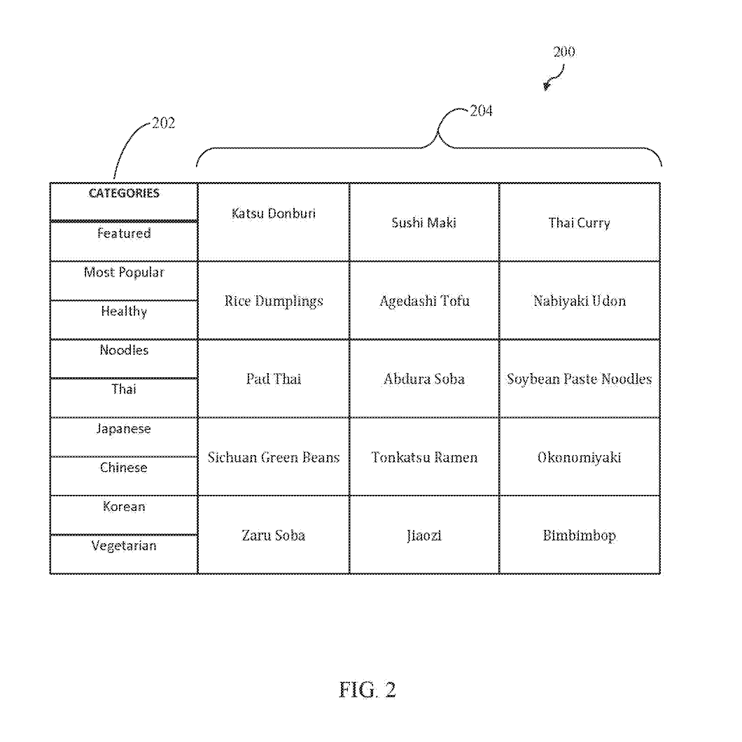

In an embodiment, shopping tool 112 provides an interface by which a user of user device 102 can search for recipes, wherein the recipes may require specialty ingredients. For example, FIG. 2 illustrates an example component 200 of a graphical user interface (GUI) that may be presented to a user by shopping tool 112 to facilitate such searching. As used herein, the term “GUI component” refers to all or a portion of a GUI that may be displayed to a user via a display or via a portion of a display (e.g., via a window within a display).

GUI component 200 includes a number of categories 202 of recipes that may be selected by a user. In particular, as shown in FIG. 2, categories 202 include “Featured,” “Most Popular,” “Healthy,” “Noodles,” “Thai,” “Japanese,” “Chinese,” “Korean” and “Vegetarian.” To the right of the list of categories, a variety of recipes 204 are identified which may also be selected by the user. In GUI component 200, recipes 204 are identified by the name of the dish that can be made using the recipe. In further embodiments, recipes 204 may be identified by images of the dishes that can be made using the recipes, or via some other representation other than or in addition to the recipe name. Likewise, recipe categories 202 may be represented using images or other types of representation other than or in addition to a text description of the category.

Selection of a category 202 or a recipe 204 may be achieved using any suitable user interface method or device. For example a pointing device such as a mouse may be used in a well-known manner to point to and click on a particular category 202 or recipe 204. As another example, if user device 102 includes a touch screen, a user may touch an area of the touch screen corresponding to a particular category 202 or recipe 204. However, these examples are not intended to be limiting and a wide variety of user interface methods or devices may be used to select a category or recipe.

In an embodiment, a user can select one category or multiple categories (e.g., from recipe categories 202 of FIG. 2). When the user selects a category, the selected category is applied as a filter or constraint in conducting a search for recipes to present to the user. For example, in one embodiment, the user may select one or more categories 202 and the selected category or categories may be communicated from shopping tool 112 to shopping engine 122 so that shopping engine 122 can identify recipes (e.g., recipes 204) that satisfy the filter(s) or constraint(s) represented thereby. Shopping engine 122 may conduct such a search by accessing recipe information in database(s) 108 to identify recipes that satisfy the relevant filter(s) or constraint(s). Shopping engine 122 may then provide an identification of the recipes (e.g., names of the recipes) that satisfy the filter(s) or constraint(s) to shopping tool 112 so that shopping tool 112 can present such identification of the recipes to the user (e.g., recipes 204 shown in FIG. 2). In some embodiments, a server administrator or a user may add tasks (e.g., recipes, projects, etc.) to database(s) 108.

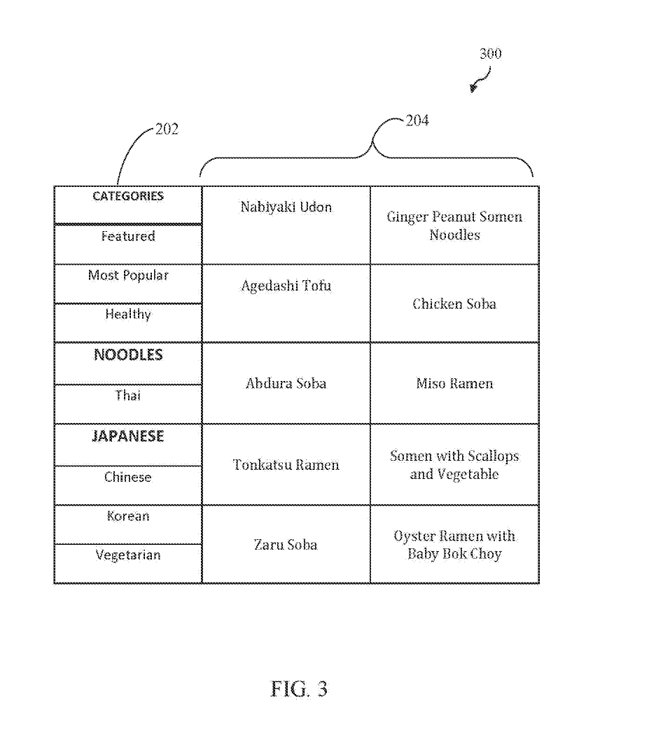

In further accordance with this example, FIG. 3 shows a GUI component 300 that may be presented to a user of shopping tool 112 after the user has selected two categories 202—namely “Noodles” and “Japanese.” In GUI component 300, the fact that each of the categories “Noodles” and “Japanese” of categories 202 has been selected by the user is indicated visually by showing the names of those categories using all capital letters and a bold font. However, it will be appreciated that any of a wide variety of techniques may be used to indicate that a certain category 202 has been selected.

Prior to the selection of one or more categories 202 by the user, recipes 204 that are shown may comprise a default set of recipes, a random set of recipes, a set of recipes that is pre-selected based on previous searches or activities of the user and/or other users, or a set of recipes selected in some manner other than the selection of the presented categories 202 by the user.

As shown in FIG. 3, in response to the user selection of the categories “Noodles” and “Japanese” of categories 202, a number of recipes 204 have been identified by shopping engine 122 that satisfy the filters/constraints represented by those of categories 202 and shopping tool 112 has presented the names of such recipes 204 to the right of the categories column. Thus, all of the recipe names shown in FIG. 3 identify recipes 204 for dishes that are Japanese dishes or dishes and that include noodles. The user may then select one of those recipes 204 to obtain more information about it, as will be discussed in more detail below.

In an embodiment, a user may select additional filters/constraints or remove existing filters/constraints at any time by selecting or de-selecting one or more categories 202. For example, a user could start out by selecting the category “Japanese” of categories 202, which would result in a variety of recipes 204 for Japanese dishes being shown. The user could then also select the category “Noodles” of categories 202, which would result in only those recipes 204 for Japanese dishes that contain noodles being shown, as is the case in FIG. 3. The user could then de-select the category “Japanese” of categories 202, which could result in additional recipes 204 being shown that include noodles but that are not limited to Japanese recipes.

Although the foregoing describes a category-based technique for searching for and identifying recipes, it is to be understood that this technique has been described by way of example only and is by no means limiting. A wide variety of other techniques may be utilized by system 100 to search for and identify recipes 204 in response to user input. For example and without limitation, keyword searching or known item (e.g., known ingredient) searching may also be used to search for and identify recipes 204 that may be of interest to a user. Furthermore, some hybrid combination of category-based, keyword-based or known-item-based searching may be used.

Additionally, although the foregoing describes a technique for searching for and identifying recipes 204 that uses a particular GUI (e.g., a GUI that includes GUI components such as GUI components 200 and 300), it is to be understood that any of a wide variety of graphical and non-graphical user interfaces may be used to implement the recipe searching functionality described herein.

As noted above, a user may interact with a user interface presented by shopping tool 112 to select a particular recipe. For example, a user may interact with GUI components 200 or 300 as shown in FIGS. 2 and 3, respectively, to select a particular recipe 204 by selecting a recipe name.

In response to the selection of a recipe 204, shopping tool 112 operates to present information about the selected recipe 204 to the user. In an embodiment, in response to the selection of a particular recipe 204, shopping tool 112 sends a request for information about the recipe to shopping engine 122. In response to receiving such request, shopping engine 122 obtains the requested information from database(s) 108 and transmits it to shopping tool 112, which in turn presents the recipe information to the user.

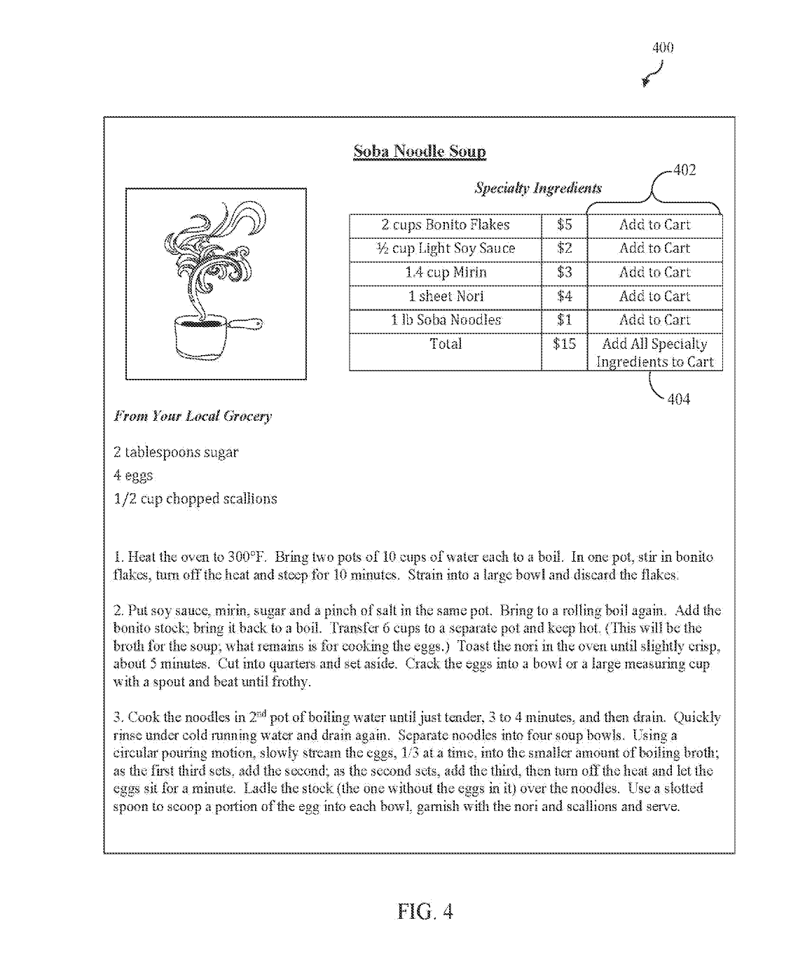

FIG. 4 depicts an example GUI component 400 that may be displayed to a user by shopping tool 112 in response to the selection of a recipe (e.g., a recipe of recipes 204 of FIGS. 2-3). As shown in FIG. 4, GUI component 400 includes a variety of information about the selected recipe, which in this case is a recipe for soba noodle soup. The recipe information is divided into three sections: (1) a list of specialty ingredients required to prepare a dish in accordance with the recipe; (2) a list of non-specialty ingredients required to prepare the dish in accordance with the recipe; and (3) complete step-by-step instructions for preparing the dish in accordance with the recipe.

With respect to the specialty ingredients, GUI component 400 also provides price information for each specialty ingredient and one or more of an interactive user interface (UI) element 402 labeled “Add to Cart” that can be activated by the user to add each specialty ingredient to a “shopping cart” (or “cart”) maintained for the user. As used herein, the term “shopping cart” refers to a record (e.g., a list, table, or other data structure) that is used to store items selected for future purchase by the user. In one embodiment, the shopping cart is maintained by shopping engine 122 and updated thereby in response to user interaction with shopping tool 112. Still other techniques may be used to maintain and update the shopping cart.

As shown in FIG. 4, a user may also interact with an interactive UI element 404 labeled “Add All Specialty Ingredients to Cart” to simultaneously add all the listed specialty ingredients to his shopping cart.

Interaction with an interactive UI element (e.g., interactive UI elements 402 and/or 404) may be achieved using any suitable user interface method or device. For example, a pointing device such as a mouse may be used in a well-known manner to point to and click on a particular interactive UI element. As another example, if user device 102 includes a touch screen, a user may touch an area of the touch screen corresponding to a particular interactive UI element. However, these examples are not intended to be limiting and a wide variety of user interface methods or devices may be used to interact with an interactive UI element.

In one embodiment, GUI component 400 may indicate to a user that a particular specialty ingredient has already been added to the user's shopping cart, such that the user need not add the specialty ingredient again. In a still further embodiment, GUI component 400 may include a portion, size, or amount of a specialty ingredient that has been increased to take into account a serving size, a number of servings desired by the user, and/or other recipes that the user has already added to his shopping cart. In accordance with such an embodiment, GUI component 400 may provide an indication to the user that the portion, size or amount of the particular specialty ingredient has been increased, and may provide an option for a number of servings (e.g., a recipe may include 4 servings and the user may double the recipe to include 8 servings).

In a further embodiment, GUI component 400 may enable the user to interact with the list of specialty ingredients by adding some, all, or different variations of the specialty ingredients from the recipe directly into the shopping cart.

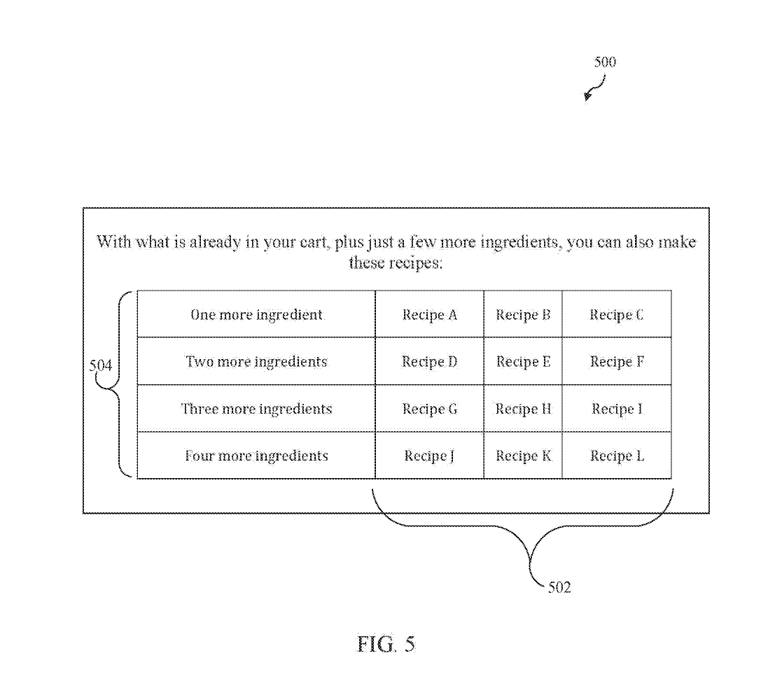

FIG. 5 depicts an example GUI component 500 that may be automatically presented to a user by shopping tool 112. For example, GUI component 500 may be presented to the user in response to a particular user interaction with shopping tool 112, such as the user adding one or more specialty ingredients to his shopping cart as discussed above in reference to FIG. 4, or the user viewing his shopping cart. GUI component 500 may also be presented to the user in response to the occurrence of some event or activity other than user interaction with shopping tool 112. The information presented in GUI component 500 may be obtained from database(s) 108 by shopping engine 122 and communicated to shopping tool 112 for presentation thereby.

As shown in FIG. 5, GUI component 500 provides the user with an identification of other recipes 502 that can be made with the specialty ingredients already in his shopping cart and with the purchase of one, two, three, or four more specialty ingredients 504. For example, GUI component 500 indicates that with only one more specialty ingredient than the user already has included in his shopping cart, the user can make three more recipes, identified as “Recipe A,” “Recipe B” and “Recipe C.” It is to be understood that depending upon the implementation, more than three recipes 502 can be identified per category and furthermore that recipes 502 requiring more than four additional specialty ingredients 504 may be identified.

The user may select any of recipes 502 identified in GUI component 500 in a like manner to that described above for selecting recipes 204 identified in GUI components 200 and 300 of FIGS. 2 and 3, respectively. In response to selecting a recipe of recipes 502, shopping tool 112 may present the user with information about the selected recipe using a GUI component similar to GUI component 400 of FIG. 4. By interacting this GUI component, the user may add to his shopping cart the additional specialty ingredients 504 necessary to complete the selected recipe of recipes 502.

As noted above, a GUI component such as GUI component 500 may be presented to a user at various times during his shopping experience. For example, if the user has a predetermined number of specialty ingredients already in his shopping cart, or if the user has remaining specialty ingredients from a previous shopping experience (or other manner of acquisition) that have been logged by shopping engine 122 into database(s) 108, shopping engine 122 may automatically generate a list of additional recipes 502 that the user can make by purchasing one, two, three, etc., additional specialty ingredients 504. Shopping engine 122 may then communicate this list to shopping tool 112, which in turn presents an identification of the listed recipes 502 to the user. The user can then select any of the identified recipes of recipes 502 to view information about that recipe. In response to the user selection of an identified recipe, shopping tool 112 will present information about the recipe along with interactive UI elements by which the user can add the remaining necessary specialty ingredients 504 to his shopping cart. In embodiments, shopping engine 122 is configured to present only additional recipes 502 that are not already in the shopping cart to the user. For instance, shopping engine 122 may determine whether one or more of the additional recipes 502 is the same as a recipe currently in the shopping cart and then remove the recipe of recipes 502 if it is the same, thus preventing duplicate recipes from being presented to the user.

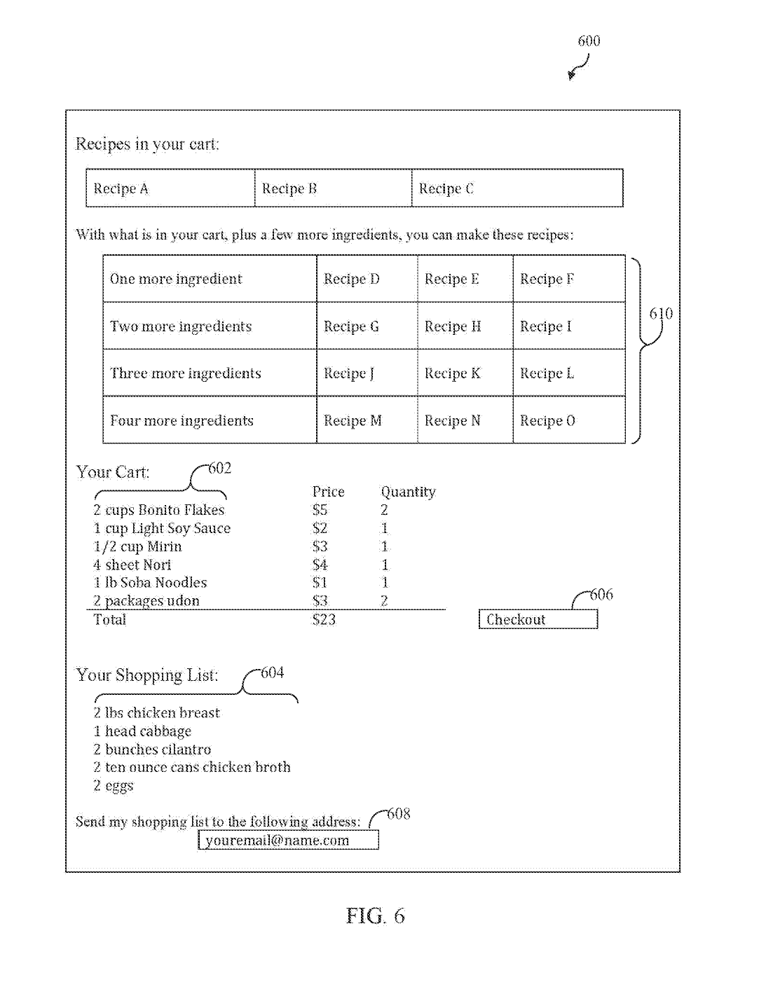

FIG. 6 depicts another example GUI component 600 that may be presented to a user by shopping tool 112. GUI component 600 may be presented, for example, when the user opts to view his shopping cart. As shown in FIG. 6, GUI component 600 includes a list 602 of the specialty ingredients that the user has added to his shopping cart (displayed under the heading “Your Cart”), a list of the recipes (e.g., recipes 204 of FIGS. 2-3) that were accessed by the user to add such ingredients (displayed under the heading “Recipes in your cart”), and a shopping list 604 of non-specialty ingredients required to complete such recipes (displayed under the heading “Your Shopping List”).

In an embodiment, the lists 602 and 604 of ingredients shown in GUI component 600 includes an amount of each ingredient that is sufficient to make the dishes associated with all of the recipes in the shopping cart. In further accordance with such an embodiment, if multiple recipes in the shopping cart contain the same ingredient (non-specialty and/or specialty), then shopping engine 122 may calculate how much of that ingredient is needed to prepare all the dishes associated with the multiple recipes and then adjust the unit amount or add a larger size portion or container of the ingredient in the user's shopping cart appropriately. In still further accordance with such an embodiment, if one unit of the ingredient is sufficient to prepare all the dishes associated with the multiple recipes, then shopping engine 122 may add only one unit of that ingredient to the user's shopping cart. In this way, the user can be assured that he is only buying as much of a particular specialty ingredient as is needed to follow his desired recipes.

In a further embodiment, when a user views a recipe, the user is also able to specify how many times he would like to use the recipe. If a user chooses, for example, to specify that he would like to follow the recipe three times, then shopping engine 122 may automatically calculate how much more of each ingredient is needed to make the quantity specified. Additionally, a serving size may be specified as described above for a single preparation of a recipe with an increased (or decreased) amount. These calculated unit amounts may then be displayed in association with the ingredients shown in GUI component 600.

In a still further embodiment, a user is permitted to add or remove specialty ingredients from his shopping cart via GUI component 600. In further accordance with such an embodiment, if a user indicates that he wants to remove a specialty ingredient from his shopping cart, the system may indicate to the user which recipes will be impacted by removing the specialty ingredient and then seek additional confirmation from the user that the specialty ingredient should be removed.

As further shown in FIG. 6, GUI component 600 includes an interactive UI element 606 labeled “Checkout.” The user can interact with such element (e.g., by pointing and clicking with a mouse or touching an appropriate portion of a touch screen display) to initiate a commercial transaction by which the specialty ingredients that have been added to the shopping cart can be purchased.

As still further shown in FIG. 6, GUI component 600 also includes a feature 608 that enables a user to specify an e-mail address where shopping list 604 of the non-specialty ingredients will be sent. This feature 608 enables such a shopping list (e.g., shopping list 604) to be sent, for example, to an e-mail inbox on a mobile device owned by the user where it can be easily referenced while shopping or to an e-mail inbox on a user's computer where it can be easily printed out in paper form. Still other methods may be used to convey shopping list 604 of non-specialty ingredients to a device owned or operated by the user, including but not limited to text messaging, downloading shopping list 604 via network(s) 104, or the like. In still further embodiments, shopping list 604 may be maintained by shopping engine 122 and later accessed by the user via shopping tool 112 or via some other means for communicating with shopping engine 122 via network(s) 104.

Finally, in embodiments, GUI component 600 also includes an identification 610 of other recipes that can be made with the specialty ingredients already in the shopping cart and with the purchase of one, two, three, or four more specialty ingredients. This aspect of GUI component 600 may serve a like function and operate in a like fashion to GUI component 500 as was previously described in reference to FIG. 5.

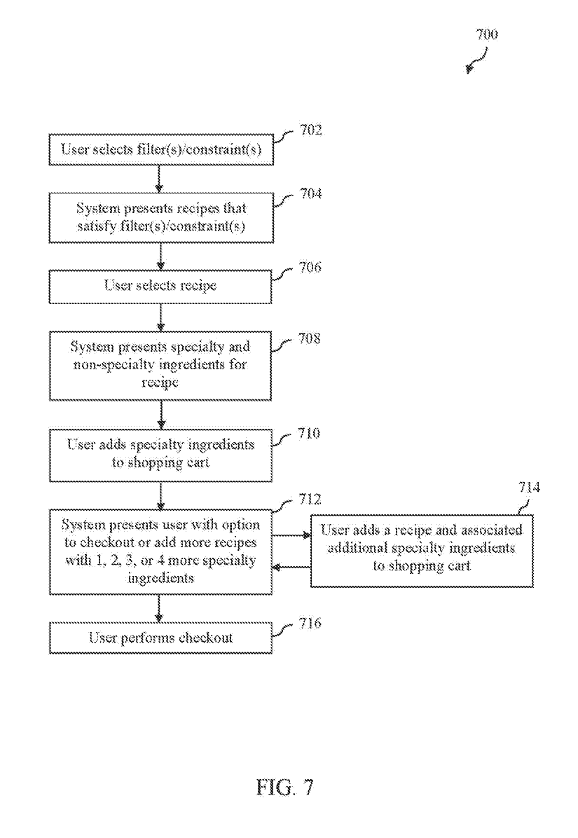

FIG. 7 depicts a flowchart 700 of an example process by which a user may interact with system 100 to identify and purchase specialty ingredients for preparing culinary dishes in accordance with an embodiment. The process of flowchart 700 is described herein by way of example only and is not intended to be limiting. Persons skilled in the relevant art(s) will appreciate that other process flows may be achieved via user interaction with system 100. Furthermore, although the process of flowchart 700 is described in reference to system 100, persons skilled in the relevant art(s) will appreciate that the process may be implemented by other systems as well.

As shown in FIG. 7, the process of flowchart 700 begins at step 702 in which a user interacts with system 100 to select one or more filters or constraints for identifying recipes. For example, with reference to example GUI component 200 of FIG. 2, the user may select one or more categories from the list of categories included in GUI component 200, wherein each category represents a filter or constraint that will be applied by system 100 to identify recipes.

At step 704, system 100 applies the selected filter(s)/constraint(s) from step 704 to recipes included in database(s) 108 to identify recipes that satisfy the filter(s)/constraint(s) and such recipes are presented to the user. For example, the names of the identified recipes (or other representations thereof) may be presented to the user via a GUI component such as GUI component 300 of FIG. 3.

At step 706, the user selects a recipe from among the recipes that were presented to the user in step 704. For example, the user may select one of the recipe names presented in GUI component 300 by using a suitable user interface method or device.

At step 708, system 100 presents to the user a list of specialty ingredients and non-specialty ingredients that are required to follow the recipe selected during step 706. For example, system 100 may present the list of specialty ingredients and non-specialty ingredients as part of a GUI component such as GUI component 400 described above in reference to FIG. 4. Thus, the list of specialty ingredients and non-specialty ingredients may be presented along with comprehensive step-by-step instructions for preparing a dish in accordance with the recipe. System 100 also presents the user with a means by which to add the identified specialty ingredients to his shopping cart. In an embodiment, such means may comprise an interactive UI element (e.g., a button labeled “Add to Cart” or “Add All Specialty Ingredients to Cart”) or the like.

At step 710, the user adds the specialty ingredients presented during step 708 to his shopping cart. For example, the user may do this by activating an interactive UI element (e.g., a button labeled “Add to Cart” or “Add All Specialty Ingredients to Cart”) or the like.

At step 712, system 100 presents the user with the option to checkout or to add more recipes for which only 1, 2, 3, or 4 more specialty ingredients are required. For example, system 100 may present the user with a GUI component such as GUI component 600 described above in reference to FIG. 6 that provides the user with an option to checkout (e.g., via interaction with a “Checkout” button or other interactive UI element) or to add recipes for which 1, 2, 3, or 4 more specialty ingredients are required (e.g., by selecting the names of certain displayed recipes).

If the user opts to checkout, then the process flows to step 716 during which a commercial transaction is initiated by which the user can purchase the specialty ingredients included in his shopping cart. However, if the user opts to add a recipe, then the process flows to step 714.

During step 714, the user can view information about the added recipe and add to his cart the additional specialty ingredients required to follow the recipe. This may occur via interaction with a GUI component such as GUI component 400 as described above in reference to FIG. 4. After this, the user may again be presented with the option of checking out or adding more recipes with 1, 2, 3, or 4 more specialty ingredients as shown by the arrow returning from step 714 to step 712. Depending upon the user's decision, the process may return to another instance of step 714 or to step 716.

In a further embodiment, the method of flowchart 700 may further include the user interacting with system 100 to cause a list of non-specialty ingredients required to follow his selected recipe(s) to be communicated to an e-mail account, device or system associated with the user.

In some example embodiments, one or more of steps 702, 704, 706, 708, 710, 712, 714 and/or 716 of flowchart 700 may not be performed. Moreover, steps in addition to or in lieu of steps 702, 704, 706, 708, 710, 712, 714, and/or 716 of flowchart 700 may be performed (some of which were described above). Further, in some example embodiments, one or more of steps 702, 704, 706, 708, 710, 712, 714, and/or 716 of flowchart 700 may be performed out of the order shown in FIG. 7, in an alternate sequence, and/or partially (or completely) concurrently with other steps.

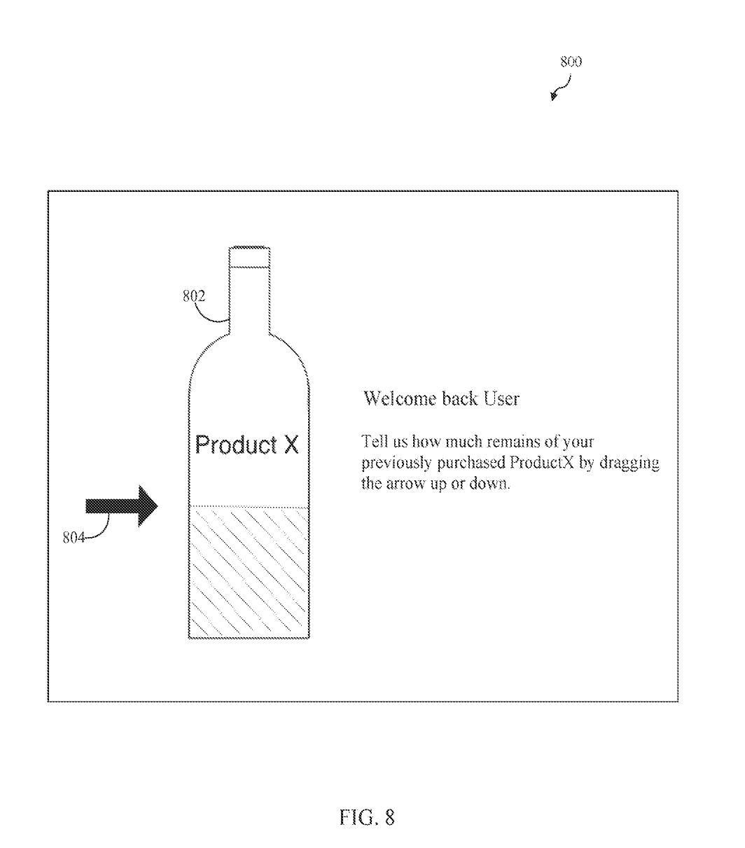

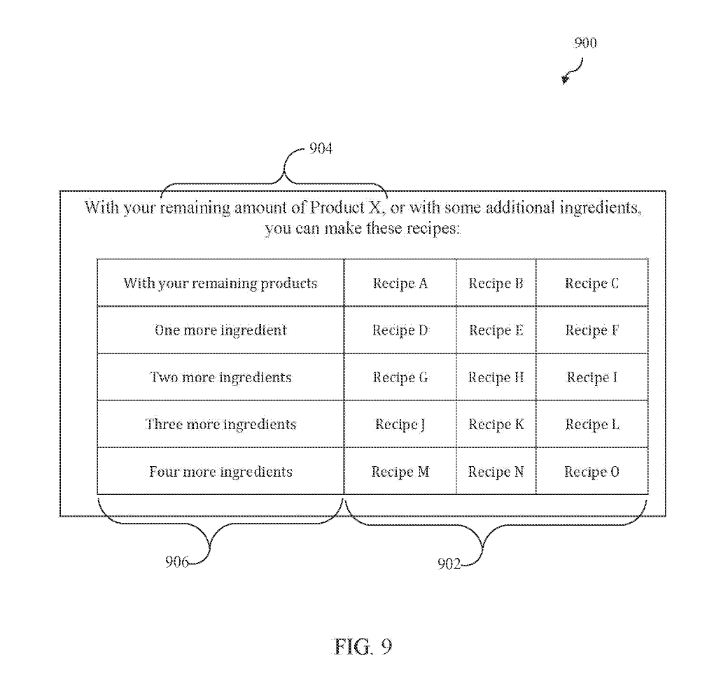

Further functionality of system 100 in accordance with an embodiment will now be described in reference to FIGS. 8 and 9. In particular, system 100 may include functionality that enables it to recognize when a user that has previously purchased specialty ingredients has logged on or otherwise begun interacting with system 100 and that enables it to access a history of the user's prior purchases. By way of example, the user may be recognized by virtue of a user ID that is used to log into system 100 or via some other suitable mechanism for recognizing users. A purchase history for the user may be maintained in database(s) 108 and then accessed by shopping engine 122 when the user logs on or otherwise begins interacting with system 100. System 100 may then show the user, via shopping tool 112, a representation of each previously-purchased product and may prompt the user to indicate how much is remaining from the purchased product. Based on the estimated quantity given to system 100 by the user, system 100 can then recommend recipes that the user can follow with the remaining specialty ingredients, or with the addition of one, two, three, etc., additional ingredients.

In accordance with this example, FIG. 8 depicts an example GUI component 800 that may be displayed by shopping tool 112 and can be used by a user to indicate how much of a previously-purchased specialty ingredient remains. As shown in FIG. 8, example GUI component 800 includes a stylized representation of a bottle 802 and a movable arrow 804 that a user can drag up or down to indicate how much of the particular specialty ingredient remains. For example, if the user wanted to indicate that approximately half of the specialty ingredient remained, then the user could utilize a suitable user interface method or device to drag arrow 804 into a position about halfway between the top and the bottom of bottle 802. Of course, various other types of user interface components can be used to enable the user to input how much of a specialty ingredient remains. For example, the user may simply type in a percentage remaining, etc.

FIG. 9 depicts an example GUI component 900 that may be presented to a user by shopping tool 112 in response to receiving an estimated quantity of a previously-purchases specialty ingredient. As shown in FIG. 9, GUI component 900 provides the user with an identification of other recipes 902 that can be made with the remaining portions of his previously-purchased specialty ingredients 904 and with the purchase of one, two, three, or four more specialty ingredients 906. For example, GUI component 900 indicates that with the remaining amount of specialty ingredients 904 the user already purchased, the user can make three recipes 902, identified as “Recipe A,” “Recipe B” and “Recipe C.” As another example, GUI component 900 indicates that with one more specialty ingredient 906 in addition to the remaining amount of specialty ingredients 904 the user has already purchased, the user can make three recipes 902, identified as “Recipe D,” “Recipe E” and “Recipe F.” It is to be understood that depending upon the implementation, more than three recipes 902 can be identified per category and furthermore that recipes requiring more than four additional specialty ingredients 906 may also be identified.

The user may select any of the recipes identified in GUI component 900 in a like manner to that described above for selecting recipes identified in GUI components 200 and 300 of FIGS. 2 and 3, respectively. In response to selecting a recipe, shopping tool 112 may present the user with information about the selected recipe using a GUI component similar to GUI component 400 of FIG. 4. By interacting this GUI component, the user may add to his shopping cart the additional specialty ingredients necessary to complete the selected recipe.

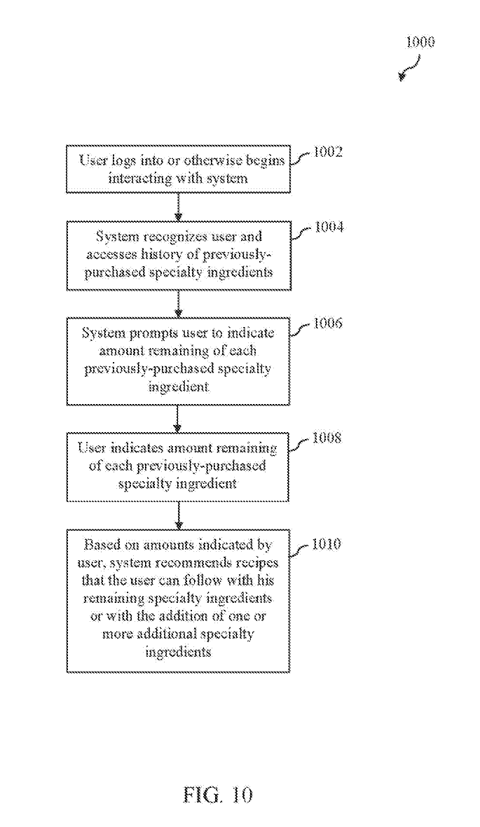

FIG. 10 depicts a flowchart 1000 of an example process by which a user may interact with system 100 to receive recommended recipes for preparing culinary dishes in accordance with an embodiment. The process of flowchart 1000 is described herein by way of example only and is not intended to be limiting. Persons skilled in the relevant art(s) will appreciate that other process flows may be achieved via user interaction with system 100. Furthermore, although the process of flowchart 1000 is described in reference to system 100, persons skilled in the relevant art(s) will appreciate that the method may be implemented by other systems as well.

As shown in FIG. 10, the process of flowchart 1000 begins at step 1002 in which a user logs into or otherwise begins interacting with system 100.

At step 1004, system 100 recognizes the user and accesses a history of specialty ingredients that were previously purchased by the user. As noted above, the user may be recognized by virtue of a user ID that is used to log into system 100 or via some other suitable mechanism for recognizing users. As also noted above, a purchase history for the user may be maintained in database(s) 108 and then accessed by shopping engine 122 when the user logs into or otherwise begins interacting with system 100.

At step 1006, system 100 prompts the user to indicate an amount remaining for each previously-purchased specialty ingredient identified during step 1004.

At step 1008, the user indicates the amount remaining of each previously-purchased specialty ingredient via interaction with system 100. For example, the user may interact with a GUI component such as GUI component 800 described above in reference to FIG. 8 to indicate an amount remaining for each previously-purchased specialty ingredient. As noted above, still other types of user interface components can be used to enable the user to input how much of each specialty ingredient remains.

At step 1010, based on the amounts indicated by the user in step 1008, system 100 recommends recipes that the user can follow with his remaining specialty ingredients or with the addition of one, two, three, etc., additional specialty ingredients. System 100 may perform this function, for example, by presenting to the user a GUI component such as GUI component 900 described above in reference to FIG. 9. The user may interact with such GUI component to access the recommended recipes. Through further interaction with system 100 the user can add the additional recipes and the specialty ingredients necessary for following such recipes to his shopping cart for subsequent purchase.

In some example embodiments, one or more of steps 1002, 1004, 1006, 1008, and/or 1010 of flowchart 1000 may not be performed. Moreover, steps in addition to or in lieu of steps 1002, 1004, 1006, 1008, and/or 1010 of flowchart 1000 may be performed (some of which were described above). Further, in some example embodiments, one or more of steps 1002, 1004, 1006, 1008, and/or 1010 of flowchart 1000 may be performed out of the order shown in FIG. 10, in an alternate sequence, and/or partially (or completely) concurrently with other steps.

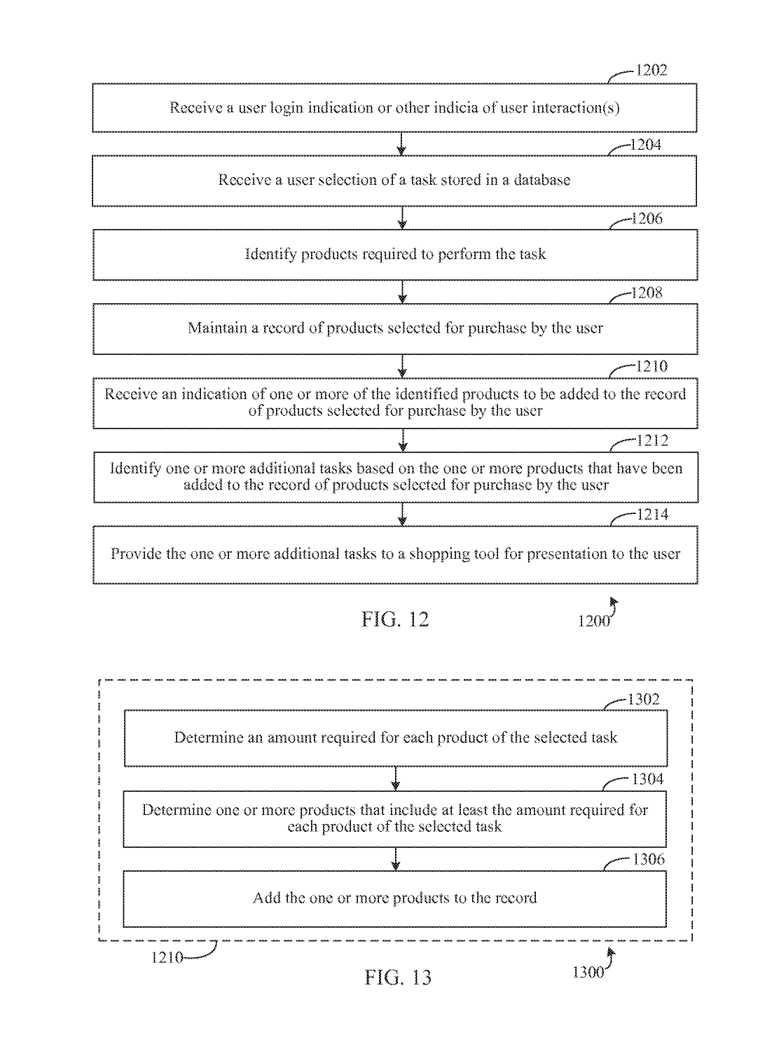

FIGS. 12-15 and their respective flowcharts will now be described. FIGS. 12-15 are described in the context of server(s) 106 and/or shopping engine 122 of system 100 of FIG. 1, although the steps described may be applicable to other components of system 100 as well as other embodiments discussed herein. Additionally, the processes of the flowcharts subsequently described may be performed in conjunction with other flowcharts described herein, in whole or in part.

FIG. 12 depicts a flowchart 1200 of an example process by which a portion of system 100 may operate to provide tasks and products, e.g., for preparing culinary dishes, accomplishing projects, etc., in accordance with embodiments. The process of flowchart 1200 is described herein by way of example only and is not intended to be limiting. Persons skilled in the relevant art(s) will appreciate that other process flows may be achieved utilizing portions of system 100. Furthermore, although the process of flowchart 1200 is described in reference to system 100 (e.g., server(s) 106 and/or shopping engine 122), persons skilled in the relevant art(s) will appreciate that the method may be implemented by other systems as well.

As shown in FIG. 12, the process of flowchart 1200 begins at step 1202 in which a user login indication or other indicia of user interaction(s) is received. For instance, server(s) 106 and/or shopping engine 122 of system 100 may receive a user login or some other indication of user interaction with system 100. In embodiments, such indications may be received from user device 102 and/or shopping tool 112. In some embodiments, server(s) 106 and/or shopping engine 122 may validate the user login indication or other indicia against user information stored in database(s) 108.

At step 1204, a user selection of a task (e.g., a recipe) stored in a database is received. For instance, server(s) 106 and/or shopping engine 122 of system 100 may receive the user selection. In embodiments, a user may select a task displayed via shopping tool 112 that is stored in database(s) 108. The selection may be provided to, and received by, server(s) 106 and/or shopping engine 122.

At step 1206, products required to perform the task are identified. For instance, server(s) 106 and/or shopping engine 122 of system 100 may identify the products by querying database(s) 108 using the selected task received in step 1204. In some embodiments, the identified products may be subsequently provided to user device 102 and/or shopping tool 112 for presentation to the user.

At step 1208, a record of products selected for purchase by the user is maintained. For example, server(s) 106 and/or shopping engine 122 of system 100 may maintain such a record. In embodiments, the record may be stored in server(s) 106 and/or database(s) 108 of system 100 while being maintained by shopping engine 122. The record may be initially empty of products, or may include products from previous user sessions. In some embodiments, the record may be a shopping cart, or cart, as described herein.

At step 1210, an indication of one or more of the identified products to be added to the record of products selected for purchase by the user is received. In embodiments, the indication may be received by server(s) 106 and/or shopping engine 122 of system 100 from user device 102 and/or shopping tool 112 of system 100. In embodiments, the indication may comprise multiple indications that may be provided to, and received by, server(s) 106 and/or shopping engine 122 as each product is identified for purchase by the user, as multiple products are identified, as all products are identified, or using any other criteria for when to provide the indication(s).

At step 1212, one or more additional tasks are identified based on the one or more products that have been added to the record of products selected for purchase by the user. For example, in embodiments, server(s) 106 and/or shopping engine 122 of system 100 may identify one or more additional tasks based upon the indications received in step 1210. In one embodiment, shopping engine 122 may query database(s) 108 for items associated with the indication of the identified items. Based on similarities of products, user preferences, user history, and/or other filters or constraints, shopping engine 122 may identify the additional tasks.

At step 1214, the one or more additional tasks are provided to a shopping tool for presentation to the user. For instance, server(s) 106 and/or shopping engine 122 of system 100 may provide the identified additional task(s) to shopping tool 112 for presentation to the user of user device 102.

In some example embodiments, one or more of steps 1202, 1204, 1206, 1208, 1210, 1212, and/or 1214 of flowchart 1200 may not be performed. Moreover, steps in addition to or in lieu of steps 1202, 1204, 1206, 1208, 1210, 1212, and/or 1214 of flowchart 1200 may be performed (some of which were described above). Further, in some example embodiments, one or more of steps 1202, 1204, 1206, 1208, 1210, 1212, and/or 1214 of flowchart 1200 may be performed out of the order shown in FIG. 12, in an alternate sequence, and/or partially (or completely) concurrently with other steps.

FIG. 13 depicts a flowchart 1300 of an example process by which a portion of system 100 may operate to provide tasks and products, e.g., for preparing culinary dishes, etc., in accordance with an embodiment. The process of flowchart 1300 is described herein by way of example only and is not intended to be limiting. Persons skilled in the relevant art(s) will appreciate that other process flows may be achieved utilizing portions of system 100. Furthermore, although the process of flowchart 1300 is described in reference to system 100 (e.g., server(s) 106 and/or shopping engine 122), persons skilled in the relevant art(s) will appreciate that the method may be implemented by other systems as well. As described, flowchart 1300 may be a further embodiment of step 1210 of flowchart 1200 described above.

As shown in FIG. 13, the process of flowchart 1300 begins at step 1302 in which an amount required for each product of the selected task is determined. For example, server(s) 106 and/or shopping engine 122 may determine from the selected task (e.g., from step 1204) that certain products are required to perform the task as well as their required amounts.

At step 1304, one or more products that include at least the amount required for each product of the selected task are determined. For instance, server(s) 106 and/or shopping engine 122 of system 100 may determine products that include at least the amount required to perform the task. In one example, if a recipe calls for 1 cup of soy sauce, a soy sauce product from among one or more soy sauce products identified in database(s) 108 may be selected if it includes at least one cup of soy sauce (e.g., a bottle of soy sauce that is at least 8 ounces). In embodiments, the determined product may be a product with the lowest amount that is greater than or equal to the required amount.

It should be noted that in embodiments, a product already stored in the record of products may include an amount that is sufficient to perform the task for which it was selected in addition to a newly selected task. In such cases, an additional product may not need to be added to the record. It should also be noted that a product already stored in the record (e.g., for a previously selected task) that has an insufficient amount for the previous task and a newly selected task may be replaced by a similar product having a greater amount sufficient for both tasks.

At step 1306, the one or more products are added to the record. For instance, server(s) 106 and/or shopping engine 122 of system 100 may maintain the record by adding the identified products to the record. After the identified products are added, an indication of the added products may be provided to shopping tool 112 for presentation to the user.

In some example embodiments, one or more of steps 1302, 1304, and/or 1306 of flowchart 1300 may not be performed. Moreover, steps in addition to or in lieu of steps 1302, 1304, and/or 1306 of flowchart 1300 may be performed (some of which were described above). Further, in some example embodiments, one or more of steps 1302, 1304, and/or 1306 of flowchart 1300 may be performed out of the order shown in FIG. 13, in an alternate sequence, and/or partially (or completely) concurrently with other steps.

FIG. 14 depicts a flowchart 1400 of an example process by which a portion of system 100 may operate to provide tasks and products, e.g., for preparing culinary dishes, etc., in accordance with an embodiment. The process of flowchart 1400 is described herein by way of example only and is not intended to be limiting. Persons skilled in the relevant art(s) will appreciate that other process flows may be achieved utilizing portions of system 100. Furthermore, although the process of flowchart 1400 is described in reference to system 100 (e.g., server(s) 106 and/or shopping engine 122), persons skilled in the relevant art(s) will appreciate that the method may be implemented by other systems as well. As described, flowchart 1400 may be a further embodiment of step 1212 of flowchart 1200 described above.

As shown in FIG. 14, the process of flowchart 1400 begins at step 1402 in which a database is queried for one or more of the products in the record and/or one or more additional products beyond the one or more products in the record. For instance, server(s) 106 and/or shopping engine 122 may query database(s) 108 for products that match required product for selected tasks (currently and/or previous selected). In some embodiments, a list of previously-acquired products of the user that is maintained by system 100, as described herein, may also be used to for querying.

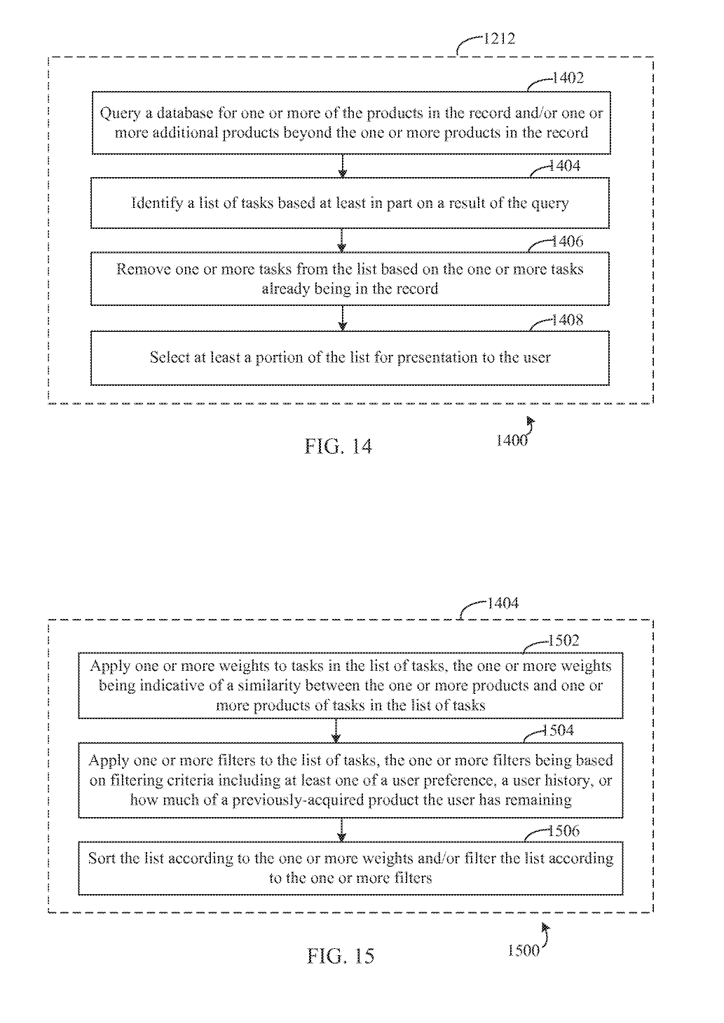

In step 1404, a list of tasks is identified based at least in part on a result of the query. For example, server(s) 106 and/or shopping engine 122 may identify one or more tasks based on the query of step 1402 for inclusion in the list of tasks. Determination of tasks to include in the list may be further based on criteria described in further detail below with respect to flowchart 1500 of FIG. 15.

In step 1406, one or more tasks may be removed from the list based on the one or more tasks already being in the record. In embodiments, server(s) 106 and/or shopping engine 122 may remove tasks from the list if the tasks have already been selected by a user (e.g., during the current session). For example, if a user selects a task and indicates that certain products required to complete the task are to be added to the record (e.g., as in flowchart 1200 of FIG. 12, described above), it may be preferable to exclude the previously selected task from the list of identified tasks in step 1404 to prevent duplication of tasks presented to the user (e.g., as in step 1214 of flowchart 1200).

In step 1408, at least a portion of the list may be selected for presentation to the user. For instance, server(s) 106 and/or shopping engine 122 may select a portion (i.e., part or all) of the list to the user as in step 1214 of flowchart 1200. According to embodiments commensurate with flowchart 1400, the provided list may exclude previously-selected tasks (as in step 1406), and the provided list may include fewer than all of the identified tasks. In an example, the query of step 1402 may result in thousands of tasks found and identified in step 1404. It may be preferred to present only a portion of the identified tasks in the list to the user.

In some example embodiments, one or more of steps 1402, 1404, 1406, and/or 1408 of flowchart 1400 may not be performed. Moreover, steps in addition to or in lieu of steps 1402, 1404, 1406, and/or 1408 of flowchart 1400 may be performed (some of which were described above). Further, in some example embodiments, one or more of steps 1402, 1404, 1406, and/or 1408 of flowchart 1400 may be performed out of the order shown in FIG. 14, in an alternate sequence, and/or partially (or completely) concurrently with other steps.

FIG. 15 depicts a flowchart 1500 of an example process by which a portion of system 100 may operate to provide tasks and products, e.g., for preparing culinary dishes, etc., in accordance with an embodiment. The process of flowchart 1500 is described herein by way of example only and is not intended to be limiting. Persons skilled in the relevant art(s) will appreciate that other process flows may be achieved utilizing portions of system 100. Furthermore, although the process of flowchart 1500 is described in reference to system 100 (e.g., server(s) 106 and/or shopping engine 122), persons skilled in the relevant art(s) will appreciate that the method may be implemented by other systems as well. As described, flowchart 1500 may be a further embodiment of step 1404 of flowchart 1400 described above.

As shown in FIG. 15, the process of flowchart 1500 begins at step 1502 in which one or more weights may be applied to tasks in the list of tasks for sorting, the one or more weights being indicative of a similarity between the one or more products and one or more products of tasks in the list of tasks. In embodiments, server(s) 106 and/or shopping engine 122 may apply the weights to one or more tasks in the list of tasks in order to sort or rank the one or more tasks. For example, tasks in the list of tasks with a high correspondence of matching products may be attributed a higher weighting and thus may be included nearer to the top of the list. Similarly, tasks in the list of tasks with a low correspondence of matching products may be attributed a lower weighting and thus may be included nearer to the bottom of the list. Weights may be applied in any manner to the tasks in the list and additional or alternative sorting criteria may be used in the embodiments herein, as would be understood by a person of skill in the relevant art(s) having the benefit of this disclosure.

In step 1504, one or more filters may be applied to the list of tasks, the one or more filters being based on filtering criteria including at least one of a user preference, a user history, or how much of a previously-acquired ingredient the user has remaining. For instance, server(s) 106 and/or shopping engine 122 may apply a filter(s) to the list of tasks in order to organize the list in a way that is pleasing to the user, such as by removing tasks from the list the user does not wish to see. In one example, if the user indicates a preference for a certain type of task (e.g., noodle recipes), the list may be filtered to include only noodle recipes. The list may be filtered according to the activity history of the user, an explicitly indicated user preference, or tasks may be filtered according products the user has previously acquired, in embodiments.

In step 1506, the list may be sorted according to the one or more weights and/or filtered according to the one or more filters. For example, server(s) 106 and/or shopping engine 122 may sort the list of tasks according to the weights and/or filter the list according to the filters as described above in steps 1502 and 1504. Tasks that are filtered out may be included at the bottom of the list of tasks, or may be excluded from the list. Accordingly, task relevance and aspects of the user shopping sessions can be used to enhance the shopping experience.

In some example embodiments, one or more of steps 1502, 1504, and/or 1506 of flowchart 1500 may not be performed. Moreover, steps in addition to or in lieu of steps 1502, 1504, and/or 1506 of flowchart 1500 may be performed (some of which were described above). Further, in some example embodiments, one or more of steps 1502, 1504, and/or 1506 of flowchart 1500 may be performed out of the order shown in FIG. 15, in an alternate sequence, and/or partially (or completely) concurrently with other steps.

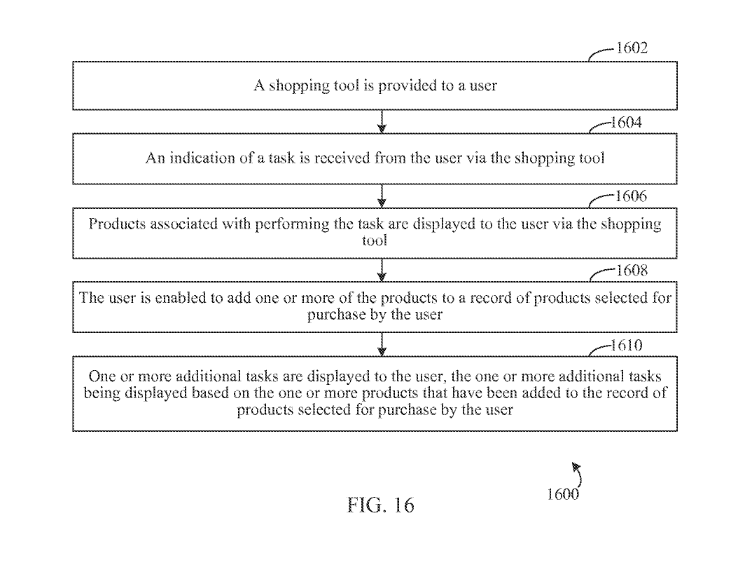

FIG. 16 and flowchart 1600 will now be described. FIG. 16 is described in the context of user device 102 and shopping tool 112 of system 100 of FIG. 1, although the steps described may be applicable to other components of system 100 as well as other embodiments discussed herein. Additionally, the processes of flowchart 1600 may be performed in conjunction with other flowcharts described herein, in whole or in part.

FIG. 16 depicts a flowchart 1600 of an example process by which a portion of system 100 may operate to provide tasks and products, e.g., for preparing culinary dishes, etc., in accordance with an embodiment. The process of flowchart 1600 is described herein by way of example only and is not intended to be limiting. Persons skilled in the relevant art(s) will appreciate that other process flows may be achieved utilizing portions of system 100. Furthermore, although the process of flowchart 1600 is described in reference to system 100 (e.g., user device 102 and/or shopping tool 112), persons skilled in the relevant art(s) will appreciate that the method may be implemented by other systems as well.

As shown in FIG. 16, the process of flowchart 1600 begins at step 1602 in which a shopping tool is provided to a user. For instance, server(s) 106 and/or user device 102 may provide shopping tool 112 to the user of user device 112. That is, a GUI of shopping tool 112, as described above may be presented on a display of user device 102 for viewing and interaction by the user. In embodiments, shopping tool 112 may comprise a portion of software that may be executed on one or more processors (e.g., of user device 102 and/or server(s) 106 of system 100). Example embodiments of shopping tool 112 are described in greater detail elsewhere herein.

At step 1604, an indication of a task is received from the user via the shopping tool. For instance, a user that is using or interacting with user device 102 may provide an indication of a task that the user wishes to perform via an interface (e.g., a GUI) of shopping tool 112. In embodiments, a user may select a task using various GUI components and input devices described herein. The indication, received by shopping tool 112, may be subsequently provided to shopping engine 122.

At step 1606, products associated with performing the task are displayed to the user via the shopping tool. For instance, shopping tool 112 may receive a list from shopping engine 122 that identifies products associated with performing the task indicated by the user at step 1604. Shopping tool 112 may receive the list of products and present the list to the user via a display of user device 102.

At step 1608, the user is enabled to add one or more of the products to a record of products selected for purchase by the user. For example, shopping tool 112 enables or allows the user to select one or more of the products displayed at step 1606, using various GUI components and input devices described herein, to indicate that the selected products are to be added to the record of products selected for purchase by the user. In embodiments, shopping tool 112 may provide identities of the selected products to shopping engine 122 for addition into the record as described herein. The record may be initially empty of products, or may include products from previous user sessions.

At step 1610, one or more additional tasks are displayed to the user, the one or more additional tasks being displayed based on the one or more products that have been added to the record of products selected for purchase by the user. In some embodiments, the record may be visually displayed to the user as a shopping cart, or cart, by shopping tool 112 and its associated GUI components and display devices of user device 102. In embodiments, server(s) 106 and/or shopping engine 122 of system 100 may identify the one or more additional tasks based upon the products added to the record in step 1608. In one embodiment, shopping engine 122 may query database(s) 108 for the added products, and based on similarities of products, user preferences, user history, and/or other filters or constraints, shopping engine 122 may identify the one or more additional tasks and provide identification of the one or more additional tasks to shopping tool 112.

In some example embodiments, one or more of steps 1602, 1604, 1606, 1608, and/or 1610 of flowchart 1600 may not be performed. Moreover, steps in addition to or in lieu of steps 1602, 1604, 1606, 1608, and/or 1610 of flowchart 1600 may be performed (some of which were described above). Further, in some example embodiments, one or more of steps 1602, 1604, 1606, 1608, and/or 1610 of flowchart 1600 may be performed out of the order shown in FIG. 16, in an alternate sequence, and/or partially (or completely) concurrently with other steps.

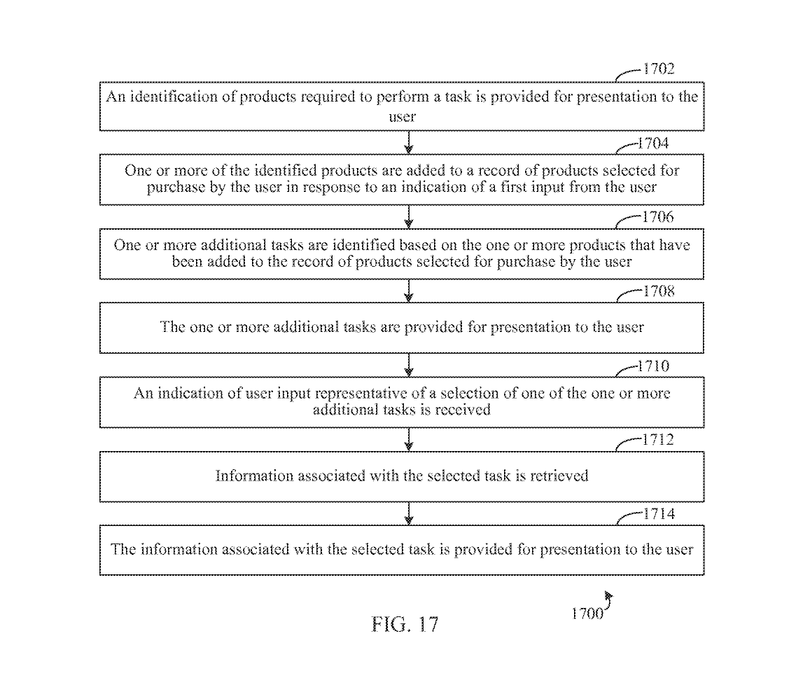

FIG. 17 and flowchart 1700 will now be described. FIG. 17 is described in the context of system 100 of FIG. 1, and the steps described may be applicable to various components of system 100 as well as other embodiments discussed herein. Additionally, the processes of the flowcharts subsequently described may be performed in conjunction with other flowcharts described herein, in whole or in part.

FIG. 17 depicts a flowchart 1700 of an example process by which a portion of system 100 may operate to provide tasks and products, e.g., for preparing culinary dishes, etc., in accordance with an embodiment. The process of flowchart 1700 is described herein by way of example only and is not intended to be limiting. Persons skilled in the relevant art(s) will appreciate that other process flows may be achieved utilizing portions of system 100. Furthermore, although the process of flowchart 1700 is described in reference to system 100 (e.g., server(s) 106 and/or shopping engine 122), persons skilled in the relevant art(s) will appreciate that the method may be implemented by other systems as well.

As shown in FIG. 17, the process of flowchart 1700 begins at step 1702 in which an identification of products required to perform a task is provided for presentation to the user. For instance, server(s) 106 and/or shopping engine 122 of system 100 may provide the identification of products as described in embodiments herein. In some embodiments, shopping tool 112 may provide the identification of products for presentation to the user. The identification of products may be provided based on a selection of a task by a user, based on a search for a task by the user, based on user history and/or preference, and/or based on other factors.

At step 1704, one or more of the identified products are added to a record of products selected for purchase by the user in response to an indication of a first input from the user. For instance, server(s) 106 and/or shopping engine 122 of system 100 may add the selected identified products to the record subsequent to a user input indication the user's desire for the products to be added. In this way, the record of products selected for purchase by the user may be maintained by server(s) 106 and/or shopping engine 122. In embodiments, the record may also be displayed to the user via shopping tool 112.

At step 1706, one or more additional tasks are identified based on the one or more products that have been added to the record of products selected for purchase by the user. For instance, server(s) 106 and/or shopping engine 122 of system 100 may identify the tasks by querying database(s) 108 using one or more of the identified products added to the record of products selected for purchase by the user in step 1704. In one embodiment, shopping engine 122 may query database(s) 108 for the identified products. Based on similarities of products, user preferences, user history, and/or other filters or constraints, shopping engine 122 may identify the one or more additional tasks.

At step 1708, the one or more additional tasks are provided for presentation to the user. For example, server(s) 106 and/or shopping engine 122 of system 100 may provide the one or more additional tasks. In embodiments, the one or more additional tasks may be provided by shopping engine 122 to shopping tool 112 for presentation to the user via a GUI of shopping tool 112.

At step 1710, an indication of user input representative of a selection of one of the one or more additional tasks is received. In embodiments, the indication may be received by server(s) 106 and/or shopping engine 122 of system 100 from user device 102 and/or shopping tool 112 of system 100. In embodiments, the indication may include information related to the selected task that would enable shopping engine 122 to retrieve information associated with the task(s).

At step 1712, information associated with the selected task is retrieved. For example, in embodiments, server(s) 106 and/or shopping engine 122 of system 100 may receive the information. In one embodiment, shopping engine 122 may receive the information as a result of a query of database(s) 108 for the task based on the indication of step 1710.

At step 1714, the information associated with the selected task is provided for presentation to the user. For instance, server(s) 106 and/or shopping engine 122 of system 100 may provide the information associated with the selected task to shopping tool 112 for presentation to the user of user device 102. In embodiments, the information may include a task name, a picture associated with the task, one or more products associated with completing the task, steps associated with completing the task, and/or the like.

In some example embodiments, one or more of steps 1702, 1704, 1706, 1708, 1710, 1712, and/or 1714 of flowchart 1700 may not be performed. Moreover, steps in addition to or in lieu of steps 1702, 1704, 1706, 1708, 1710, 1712, and/or 1714 of flowchart 1700 may be performed (some of which were described above). Further, in some example embodiments, one or more of steps 1702, 1704, 1706, 1708, 1710, 1712, and/or 1714 of flowchart 1700 may be performed out of the order shown in FIG. 17, in an alternate sequence, and/or partially (or completely) concurrently with other steps.

### 4. Embodiment Variations

Although the foregoing describes a system and method that recommends recipes based on specialty ingredients, this description does not preclude the inclusion of recipe suggestions that contain no specialty ingredients. For example, using the categories depicted in GUI components 200 and 300 of FIGS. 2 and 3, respectively, a user might be able to select and view a variety of recipes that fit within the chosen filter(s)/constraint(s), including both recipes that do and do not include any of the specialty ingredients available for purchase.

Also, system 100 was previously described in the context of an embodiment that enabled users to identify and purchase specialty ingredients required to prepare culinary dishes, such as culinary dishes including specialty ethnic ingredients. However, system 100 is not limited to that context and can advantageously be used to enable a user of user device 102 to identify and purchase products required to perform other tasks. For example, the systems and methods described above can be extended to enable a user to identify and purchase products required to perform other types of tasks such as beverage preparation (mixology), home improvement or maintenance projects, automotive repair or maintenance projects, computer upgrade or maintenance projects, arts and crafts projects, event planning projects, or the like.

For example, system 100 can enable a user to search for desired home improvement projects and can identify items (e.g., tools, hardware items, protective gear, etc.) necessary for performing the home improvement project, which the user can then add to an electronic shopping cart. System 100 can further recommend additional home improvement projects that can be carried out by using the items that the user has already added to his shopping cart or by adding one, two, three, etc., additional items. The user may be further enabled to access instructions associated with such home improvement projects and to add necessary items associated therewith to his shopping cart.

In accordance with a further embodiment, system 100 may enable a returning user to indicate how much remains of previously-purchased item used for a home improvement project and then, based on this information, recommends additional home improvement projects that can be carried out by using the remaining items or by adding one, two, three, etc., additional items.

Based on the foregoing example involving home improvement projects, persons skilled in the relevant art(s) will readily appreciate how the systems and methods described above can also be extended to other types of tasks, including but not limited to beverage preparation (mixology), automotive repair or maintenance projects, computer upgrade or maintenance projects, arts and crafts projects, event planning projects, or the like.

In the context of culinary embodiments, system 100 may maintain a user record (e.g., a “pantry”) in shopping engine 122 and/or in database(s) 108 that may include, without limitation, a record of items previously acquired by the user (e.g., through purchase, home gardens, etc.). A returning user may be prompted by system 100 to view one or more recipes that may be made using the existing, previously-acquired ingredients in the pantry. Previously-acquired ingredients includes ingredients previously purchased according to the described embodiments and/or ingredients otherwise acquired. A returning user may also be prompted to enter ingredients and amounts into the pantry record, and to indicate amounts of ingredients currently in the pantry to update the pantry, as described above. In embodiments in which a returning user selects a recipe, as described herein, system 100 may utilize information associated with the pantry to determine amounts of ingredients to add to the shopping cart. In other embodiments, the user may be prompted to enter amounts currently in possession of the user for individual ingredients. In the context of other variations, a “tool box” or other bin may be utilized as a record for tracking products and/or materials a user currently possesses (e.g., previously-acquired products/materials).

Additionally, in embodiments, a user may create a list of favorites (e.g., items relating to tasks, products, and/or the like) that may be stored as a record in shopping engine 122 and/or in database(s) 108. The user may review items stored as favorites in the context of the embodiments described herein. For example, a returning user may review and select a favorite recipe stored by system 100, and in response, system 100 may allow the user to view, select, and or purchase ingredients for the recipe in accordance with the described embodiments.

In some embodiments, as noted above, a server administrator or a user may add tasks (e.g., recipes, projects, etc.) to database(s) 108. Tasks added by a user may be stored in the pantry or a tool box (or bin) of the user, in the profile of the user, and/or the like, or may be added to a system task database in database(s) 108, for example, after approval by a server administrator. A user may add tasks using a GUI of shopping tool 112 and/or a template presented to the user similar to example GUI component 400 of FIG. 4 with empty fields for the user to enter data describing the task. Similarly, a server administrator may add tasks to the system to be stored in database(s) 108 using a GUI or other data entry techniques as would be apparent to one of skill in the relevant art(s) having the benefit of this disclosure.

### 5. Example Processor-Based System Implementation

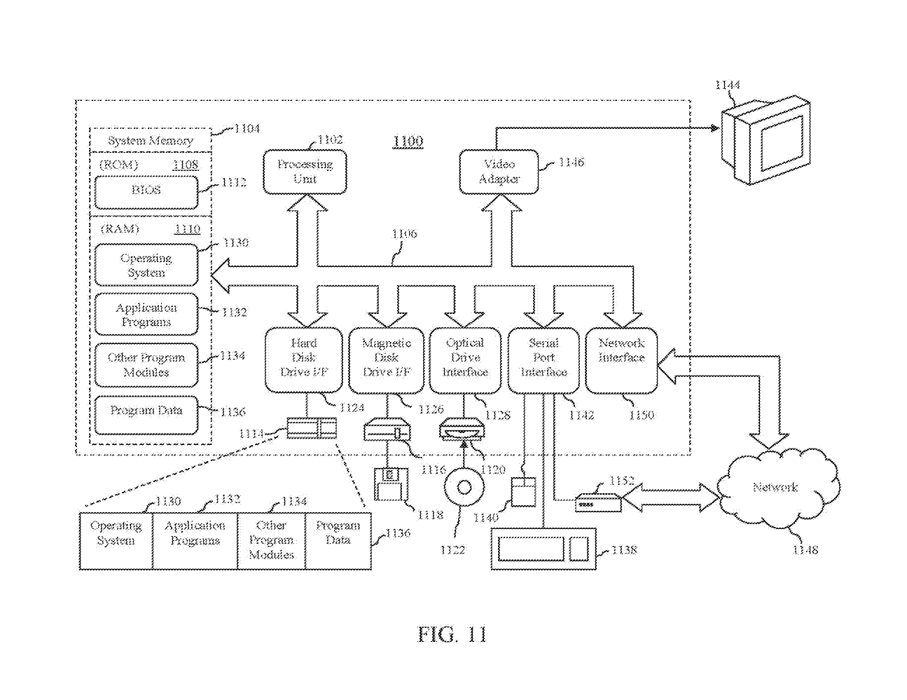

FIG. 11 depicts an example processor-based computer system 1100 that may be used to implement various embodiments described herein. For example, system 1100 may be used to implement any of the components of system 100 as described above in reference to FIG. 1, including user device 102 or any of server(s) 106. System 1100 may also be used to implement any of the steps of flowchart 700 as described above in reference to FIG. 7, flowchart 1000 as described above in reference to FIG. 10, flowchart 1200 as described above in reference to FIG. 12, flowchart 1300 as described above in reference to FIG. 13, flowchart 1400 as described above in reference to FIG. 14, flowchart 1500 as described above in reference to FIG. 15, flowchart 1600 as described above in reference to FIG. 16, and/or flowchart 1700 as described above in reference to FIG. 17. The description of system 1100 provided herein is provided for purposes of illustration, and is not intended to be limiting. Embodiments may be implemented in further types of computer systems, as would be known to persons skilled in the relevant art(s).

As shown in FIG. 11, system 1100 includes a processing unit 1102, a system memory 1104, and a bus 1106 that couples various system components including system memory 1104 to processing unit 1102. Processing unit 1102 may comprise one or more microprocessors or microprocessor cores. Bus 1106 represents one or more of any of several types of bus structures, including a memory bus or memory controller, a peripheral bus, an accelerated graphics port, and a processor or local bus using any of a variety of bus architectures. System memory 1104 includes read only memory (ROM) 1108 and random access memory (RAM) 1110. A basic input/output system 1112 (BIOS) is stored in ROM 1108.

System 1100 also has one or more of the following drives: a hard disk drive 1114 for reading from and writing to a hard disk, a magnetic disk drive 1116 for reading from or writing to a removable magnetic disk 1118, and an optical disk drive 1120 for reading from or writing to a removable optical disk 1122 such as a CD ROM, DVD ROM, BLU-RAY™ disk or other optical media. Hard disk drive 1114, magnetic disk drive 1116, and optical disk drive 1120 are connected to bus 1106 by a hard disk drive interface 1124, a magnetic disk drive interface 1126, and an optical drive interface 1128, respectively. The drives and their associated computer-readable media provide nonvolatile storage of computer-readable instructions, data structures, program modules and other data for the computer. Although a hard disk, a removable magnetic disk and a removable optical disk are described, other types of computer-readable storage devices and storage structures can be used to store data, such as flash memory cards, digital video disks, random access memories (RAMs), read only memories (ROM), and the like.

A number of program modules may be stored on the hard disk, magnetic disk, optical disk, ROM, or RAM. These program modules include an operating system 1130, one or more application programs 1132, other program modules 1134, and program data 1136. In accordance with various embodiments, the program modules may include computer program logic that is executable by processing unit 1102 to perform any or all of the functions and features of any of the components of system 100 as described above in reference to FIG. 1, including user device 102 or any of servers) 106. The program modules may also include computer program logic that, when executed by processing unit 1102, performs any of the steps or operations shown or described in reference to flowchart 700 of FIG. 7 and flowchart 1000 of FIG. 10.

A user may enter commands and information into system 1100 through input devices such as a keyboard 1138 and a pointing device 1140. Other input devices (not shown) may include a microphone, joystick, game controller, scanner, or the like. In one embodiment, a touch screen is provided in conjunction with a display 1144 to allow a user to provide user input via the application of a touch (as by a finger or stylus for example) to one or more points on the touch screen. These and other input devices are often connected to processing unit 1102 through a serial port interface 1142 that is coupled to bus 1106, but may be connected by other interfaces, such as a parallel port, game port, or a universal serial bus (USB). Such interfaces may be wired or wireless interfaces.

Display 1144 is also connected to bus 1106 via an interface, such as a video adapter 1146. In addition to display 1144, system 1100 may include other peripheral output devices (not shown) such as speakers and printers.

System 1100 is connected to a network 1148 (e.g., a local area network or wide area network such as the Internet) through a network interface or adapter 1150, a modem 1152, or other suitable means for establishing communications over the network. Modem 1152, which may be internal or external, is connected to bus 1106 via serial port interface 1142.

As used herein, the terms “computer program medium,” “computer-readable medium,” and “computer-readable storage medium” are used to generally refer to storage devices or storage structures such as the hard disk associated with hard disk drive 1114, removable magnetic disk 1118, removable optical disk 1122, as well as other storage device or storage structures such as flash memory cards, digital video disks, random access memories (RAMs), read only memories (ROM), and the like. Such computer-readable storage media are distinguished from and non-overlapping with communication media (do not include communication media). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media.

As noted above, computer programs and modules (including application programs 1132 and other program modules 1134) may be stored on the hard disk, magnetic disk, optical disk, ROM, or RAM. Such computer programs may also be received via network interface 1150, serial port interface 1142, or any other interface type. Such computer programs, when executed or loaded by an application, enable computer 1100 to implement features of embodiments discussed herein. Accordingly, such computer programs represent controllers of the system 1100.

Embodiments are also directed to computer program products comprising software stored on any computer useable medium. Such software, when executed in one or more data processing devices, causes a data processing device(s) to operate as described herein. Embodiments of the present invention employ any computer-useable or computer-readable medium, known now or in the future. Examples of computer-readable mediums include, but are not limited to storage devices and storage structures such as RAM, hard drives, floppy disks, CD ROMs, DVD ROMs, zip disks, tapes, magnetic storage devices, optical storage devices, MEMs, nanotechnology-based storage devices, and the like.

In alternative implementations, system 1100 may be implemented as hardware logic/electrical circuitry or firmware. In accordance with further embodiments, one or more of these components may be implemented in a system-on-chip (SoC). The SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

### 6. Conclusion

While various embodiments have been described above, it should be understood that they have been presented by way of example only, and not limitation. It will be apparent to persons skilled in the relevant art(s) that various changes in form and details can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A system that enables a user to identify and purchase products required to perform a task, comprising:
a shopping engine that is configured to:
identify products required to perform a task;
maintain a record of products selected for purchase by the user;
receive an indication of one or more of the identified products to be added to the record of products selected for purchase by the user;
identify one or more additional tasks based on the one or more products that have been added to the record of products selected for purchase by the user; and
provide the one or more additional tasks to a shopping tool for presentation to the user.

2. The system of claim 1, wherein each of the task and the one or more additional tasks comprises a recipe, and wherein each of the products comprises an ingredient.

3. The system of claim 1, wherein the shopping engine is configured to identify the one or more additional tasks based on the one or more products that have been added to the record of products selected for purchase by the user by:
identifying at least one additional task that can be performed using the one or more products that have been added to the record of products selected for purchase by the user or using one or more additional products beyond the one or more products that have been added to the record of products selected for purchase by the user.

4. The system of claim 3, wherein the at least one additional task comprises a plurality of additional tasks; and
wherein the shopping engine is configured to:
filter the plurality of additional tasks for the presentation to the user based on one or more filtering criteria, and/or
sort the plurality of additional tasks for the presentation to the user based on at least a weighting;
the weighting being indicative of a similarity between the one or more ingredients and one or more ingredients of the list of recipes, and
the one or more filtering criteria comprising at least one of a constraint, a user preference, a user history, or how much of a previously-acquired ingredient the user has remaining.

5. The system of claim 3, wherein the shopping engine is configured to:
determine whether an additional task of the at least one additional task is the same as the task; and
remove the additional task from the at least one additional task in response to determining the additional task is the same as the task.

6. The system of claim 3, wherein the shopping engine is configured to:
add the one or more identified products to the record of products selected for purchase by the user in response to the indication of one or more of the identified products to be added to the record of products selected for purchase by the user;
wherein each of the one or more identified products comprises a smallest amount of each of the one or more identified products that is greater than or equal to an amount required to perform the task.

7. The system of claim 1, wherein the shopping engine is configured to:
receive an indication that the user has selected an additional task of the at least one additional task;
retrieve information associated with the selected additional task; and
provide the information to a shopping tool for presentation to the user.

8. A system that enables a user to identify and purchase products required to perform a task, comprising:
a shopping engine that is configured to:
maintain a record of products that a user has previously acquired;
receive an indication of how much remains of each product that the user has previously acquired;
identify one or more tasks based on at least the indication; and
provide the one or more tasks to a shopping tool for presentation to the user.

9. The system of claim 8, wherein each product comprises an ingredient, and wherein each task comprises a recipe.

10. The system of claim 8, wherein the shopping engine is configured to:
maintain a record of products selected for purchase by the user; and
identify the one or more tasks based additionally on the record of products selected for purchase by the user.

11. The system of claim 8, wherein the shopping engine is configured to identify the one or more tasks based on at least the indicated amount remaining of each product that the user has previously acquired by:
identifying at least one task that can be performed using the remaining amount of each product that the user has previously acquired or using one or more additional products in addition to the remaining amount of each product that the user has previously acquired.

12. The system of claim 8, wherein the shopping engine is configured to:
receive an indication that the user has selected one of the one or more tasks;
retrieve information associated with the selected task, the information including at least one of a description of the selected task or identification of products required to perform the selected task; and
provide the information to a shopping tool for presentation to the user.

13. The system of claim 12, wherein the shopping engine is configured to:
add one or more of the products to a record of products selected for purchase by the user in response to an indication by the user that the one or more of the products are to be added to the record of products selected for purchase by the user;
wherein each of the one or more products comprises a smallest amount of each of the one or more products that is greater than or equal to an amount required to perform the task.

14. A method for enabling a user to identify and purchase products required to perform a task, comprising:
providing, for presentation to the user, an identification of products required to perform a task;
in response to an indication of a first input from the user, adding one or more of the identified products to a record of products selected for purchase by the user;
identifying one or more additional tasks based on the one or more products that have been added to the record of products selected for purchase by the user; and
providing, for presentation to the user, the one or more additional tasks.

15. The method of claim 14, wherein each of the task and the one or more additional tasks comprises a recipe, and wherein each of the products comprises an ingredient.

16. The method of claim 14, wherein identifying the one or more additional tasks based on the one or more products that have been added to the record of products selected for purchase by the user comprises:
identifying at least one additional task that can be performed using the one or more products that have been added to the record of products selected for purchase by the user or using one or more additional products beyond the one or more products that have been added to the record of products selected for purchase by the user.

17. The method of claim 14, further comprising:
receiving an indication of user input representative of a selection of one of the one or more additional tasks;
retrieving information associated with the selected task; and
providing, for presentation to the user, the information associated with the selected task.

18. The method of claim 17, further comprising:
providing, for presentation to the user, an identification of products required to perform the selected task; and
receiving an indication of user input representative of a selection of at least one of the products required to perform the selected task;
adding one or more of the products required to perform the selected task to the record of products selected for purchase by the user based at least on the indication of user input representative of a selection of at least one of the products required to perform the selected task.

19. The method of claim 14, further comprising at least one of:
receiving an input representative of one or more filters including at least one of a constraint, a user preference, user history data, or an amount of a previously-acquired product the user has remaining; or
determining a similarity between products of the one or more additional tasks and the products required to perform the task; and
wherein providing, for presentation to the user, the one or more additional tasks is performed based at least in part on the one or more filters and/or the similarity.

20. The method of claim 19, further comprising:
receiving an indication of user input representative of a selection of one of the one or more identified additional tasks;
retrieving information associated with the selected identified additional task; and
providing, for presentation to the user, the information associated with the selected identified additional task.

21. The method of claim 20, further comprising:
providing, for presentation to the user, an identification of products required to perform the selected identified additional task; and
adding at least one product of the products required to perform the selected identified additional task to the record of products selected for purchase by the user subsequent to the at least one product being selected by the user.

22. A computer-readable storage medium having computer program instructions recorded thereon that, when executed, enable a processor-based system to perform a method, the method comprising:
providing a shopping tool to a user;
receiving an indication of a task from the user via the shopping tool;
displaying, via the shopping tool, products associated with performing the task to the user;
enabling the user to add one or more of the products to a record of products selected for purchase by the user; and
displaying one or more additional tasks to the user, the one or more additional tasks being displayed based on the one or more products that have been added to the record of products selected for purchase by the user.

23. The computer-readable medium of claim 22, wherein each of the task and the one or more additional tasks comprises a recipe, and wherein each of the products comprises an ingredient.

24. The computer-readable medium of claim 22, wherein the method further comprises:
receiving a user input via the shopping tool that is representative of a selection of an additional task of the one or more additional tasks; and
displaying, via the shopping tool, information associated with performing the additional task to the user;

25. The computer-readable medium of claim 24, wherein the method further comprises:
providing an identification of products required to perform the selected additional task and a means for adding each of the products required to perform the selected additional task to the record of products selected for purchase by the user.

26. The computer-readable medium of claim 22, wherein the method further comprises:
receiving user input via the shopping tool that is representative of one or more filters including at least one of a constraint, a user preference, user history data, or an amount of a previously-acquired product the user has remaining;
wherein displaying includes displaying the one or more filtered tasks that satisfy the one or more filters to the user via the shopping tool.

27. The computer-readable medium of claim 26, wherein the method further comprises:
prompting the user to indicate how much remains of each product that the user has previously-acquired;
wherein prompting includes at least one of:
presenting a graphical depiction of one or more of each product;
presenting a description of one or more of each product and a corresponding input field; or
presenting an option to the user to import data corresponding to one or more of each product from a user-information database.
